(19) United States
(12) Patent Application Publication
(10) Pub. No.: US 2004/0103406 A1
(43) Pub. Date: May 27, 2004

(54) Method and apparatus for autonomic compiling of a program

(75) Inventor: Sushma Bharat Patel, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/302,398

(22) Filed: Nov. 21, 2002

(51) Int. Cl. G06F 9/44

(52) U.S. Cl. 717/140; 717/163; 717/124

(57) ABSTRACT

A method, apparatus, and computer instructions for correcting compiler errors. A database is searched to obtain keywords in which error messages are associated with keywords in response to an error originating from a source file during compiling of the source file. The keywords are used to construct a search for a correct source file. The correct source file is retrieved from a source based on a search using the keywords. The correct source file is compiled with other source files.

### BACKGROUND OF THE INVENTION

1. Technical Field

The present invention relates generally to an improved data processing system, and in particular, to a method and apparatus for processing data. Still more particularly, the present invention provides a method and apparatus for compiling a program.

2. Description of Related Art

Programs are typically written in a source code, which is a higher-level programming language, such as C or Java. A program written in this type of source code is then translated into a lower-level language for execution. The source code may be translated into machine language in many cases. In some cases, such as with Java, the source code is translated into bytecodes.

In compiling a program, the program may be linked to other files, such as library files or other source code files, as part of the process to generate an executable program. If a file is missing or corrupt that is required to be linked to the program, an error message is generated. If a file is missing or corrupt, the programmer is then required to identify the missing or corrupt file and replace it with a replacement file. Such a procedure may be tedious and often is time intensive. The programmer reviews a log to determine whether compile errors have occurred and then must work through the errors and recompile the program. This process requires the attention of the programmer during certain portions of the compiling process. The process may be lengthened depending on when the programmer is able to identify errors and find replacement files. Therefore, it would be advantageous to have an improved method, apparatus, and computer instructions for autonomic compiling of a program.

### SUMMARY OF THE INVENTION

The present invention provides a method, apparatus, and computer instructions for correcting compiler errors. A database is searched to obtain keywords in which error messages are associated with keywords in response to an error originating from a source file during compiling of the source file. The keywords are used to construct a search for a correct source file. The correct source file is retrieved from a source based on a search using the keywords. The correct source file is compiled with other source files.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram illustrating a data processing system in which the present invention may be implemented;

FIG. 3 is a diagram illustrating components used in compiling a program in accordance with a preferred embodiment of the present invention;

FIG. 4 is an example of errors generated by a test server in accordance with a preferred embodiment of the present invention;

FIG. 5 is a diagram illustrating an entry in a database used in identifying source files in accordance with a preferred embodiment of the present invention;

FIG. 6 is a flowchart of a process used for autonomically compiling a program in accordance with a preferred embodiment of the present invention;

FIG. 7 is a flowchart of a process used for processing a query in accordance with a preferred embodiment of the present invention; and

FIG. 8 is a flowchart of a process used for rating search engines in a database in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 and server 106 are connected to network 102 along with storage unit 108. In addition, clients 110, 112, and 114 are connected to network 102. These clients 110, 112, and 114 may be, for example, personal computers or network computers. In the depicted example, server 104 provides data, such as boot files, Web pages, library files, operating system images, and applications to clients 110-114. Clients 110, 112, and 114 may be clients to server 104 and/or server 106. Network data processing system 100 may include additional servers, clients, and other devices not shown. Clients 110-114 may be used to compile programs from source files in these examples.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

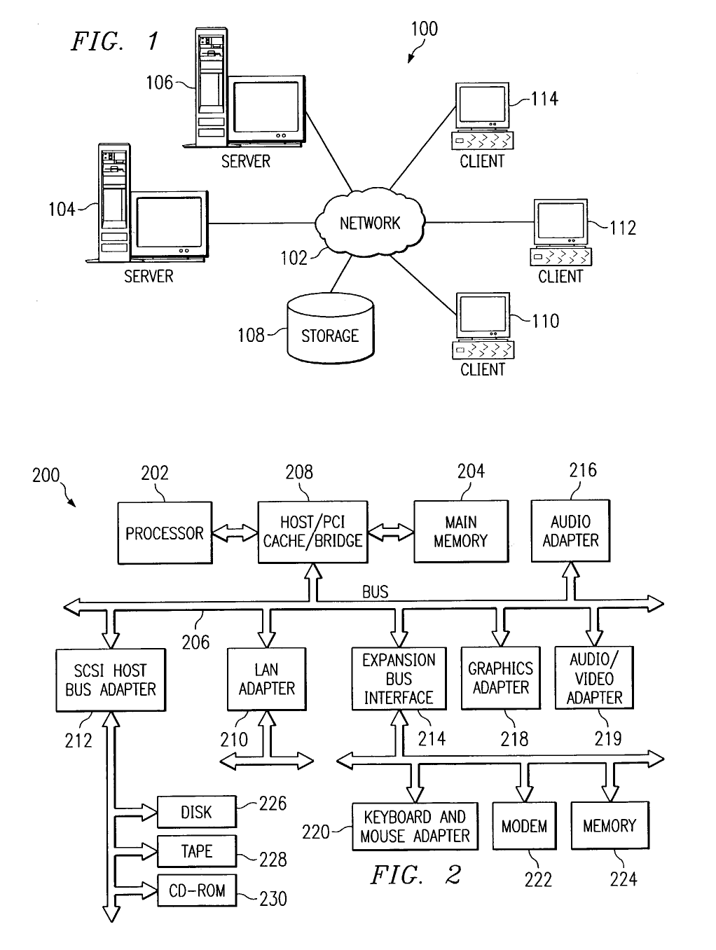

Turning now to FIG. 2, a block diagram illustrating a data processing system is depicted in which the present invention may be implemented. Data processing system 200 is an example of a client computer.

Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM drive 230.

An operating system runs on processor 202 and is used to coordinate and provide control of various components within data processing system 200 in FIG. 2. The operating system may be a commercially available operating system, such as Windows XP, which is available from Microsoft Corporation. An object oriented programming system such as Java may run in conjunction with the operating system and provide calls to the operating system from Java programs or applications executing on data processing system 200. “Java” is a trademark of Sun Microsystems, Inc. Instructions for the operating system, the object-oriented operating system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The present invention provides an improved method, apparatus, and computer instructions for compiling a computer program. The mechanism of the present invention provides a resource tool that is used to identify libraries and supporting files when a compiler-generated error occurs. This tool provides for an autonomic function in which compiling of the program may continue even though an error has occurred. The mechanism of the present invention also locates and downloads the correct file in response to an error identifying a file as being missing or incorrect. Once the appropriate file is downloaded, the compiling process is continued.

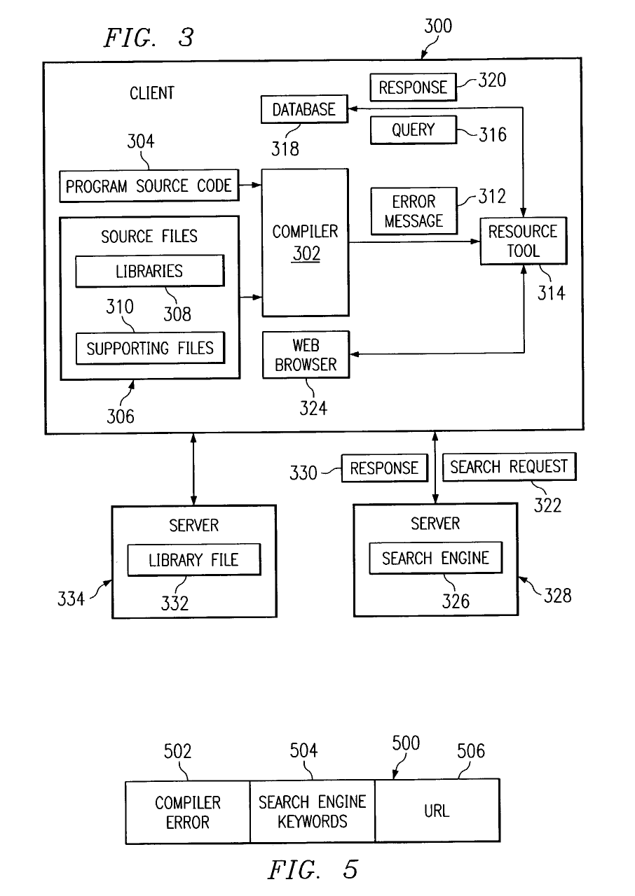

With reference now to FIG. 3, a diagram illustrating components used in compiling a program is depicted in accordance with a preferred embodiment of the present invention. In this example, client 300 is an example of a client, such as client 110 in FIG. 1.

Client 300 contains compiler 302, which is used to compile a source file, program source code 304. In these examples, such as program source code 304 is for a Java program. Of course, the mechanism of the present invention may be applied to any type of source code that is compiled to form a program. Source files 306 are used by compiler 302 as part of the process of compiling program source code 304. These source files include libraries 308 and supporting files 310. Supporting files 310 may take various forms, including, for example, a bytecode interpreter, an abstraction over system threads, and a header file.

During compiling of program source code 304 with source files 306, error message 312 may be generated. If the error occurs because a library or other supporting file is missing, incorrect, or corrupt, resource tool 314 will process the error. Other types of errors, such as syntax errors or logical errors are not handled by the mechanism of the present invention.

Upon receiving error message 312, resource tool 314 parses and analyzes the message. Upon identifying the error in error message 312 as indicating a missing or incorrect file, resource tool 314 generates a query, query 316, to database 318 using the error message. In this example, query 316 includes the name of the missing or incorrect file as a key into the database. Response 320 is returned to resource tool 314 in which this response contains the results of the search. The values returned in response 320 include keywords for use in searching for the appropriate file. If no entry is found, the mechanism of the present invention generates an entry in database 318. In these examples, the initial key is the name of the file that is identified as missing or incorrect. A file that is incorrect may be one that is corrupt or is an incorrect version. The initial search engine keyword also is the name of the missing or incorrect file. The source for the needed file is a source outside of the compiler or build system. Typically, the source for the file is external to the data processing system on which the compiling occurs. For example, the source may be a Web server or FTP server accessible through the Internet.

Resource tool 314 uses these values to generate and send search request 322 through Web browser 324. This search request is sent to search engine 326 at server 328. Server 328 may be implemented using, for example, server 104 in FIG. 1. In addition, database 318 also may include location information, such as URLs associated with the keywords to identify search engines for use in generating the search.

Additionally, a rating system may be implemented in database 318 in which successful results from a search engine will increase the rating of that particular engine in database 318. In selecting the appropriate URL, database 318 may use the search engine with the highest rating. This rating system may be further refined by rating search engines for different types of source files such that one search engine may have a higher rating for one type of library file while another search engine may have a higher rating for a different type of library file. Examples of library files include a package Servlet API 2.1.1 and a vector package, java.util.vector. These packages are Java packages in the examples. Of course, other types of library files may be needed depending on the particular implementation. Initially, a user or database programmer will identify and select search engines. The particular search engines used will vary depending on the ratings that occur.

Response 330 is returned to Web browser 324 and used by resource tool 314 to locate the appropriate file that is needed to compile program source code 304. Response 330 may include location information, such as a universal resource locator (URL), for the needed file. In this example, the location information is used to obtain library file 332 on server 334. Server 334 may be implemented as server 106 in FIG. 1. With this location information, resource tool 314 downloads library file 332 using Web browser 324.

After library file 332 is received, resource tool 314 will set up the appropriate classpath or classpaths and place library file 332 in the appropriate directory. Alternatively, depending on the type of error, statements may be included in a file containing the error. Thereafter, compilation of program source code 304 by compiler 302 may be reinitiated by resource tool 314. Further, a message or other notification may be sent to a user or programmer identifying the file and changes made. In this manner, resource tool 314 provides for an automatic compilation of program source code 304 in which errors may be identified and corrected as part of an autonomic computing system.

Turning next to FIG. 4, an example of errors generated by a test server is depicted in accordance with a preferred embodiment of the present invention. Error message 400 contains 10 errors and identifies a missing package needed to correctly compile the servlet. The mechanism of the present invention will parse error message 400 to identify a name of a package or method. In this case, the name is Servlet API 2.1.1. This name is used as a key into the database used as part of the process to locate missing or corrupted packages.

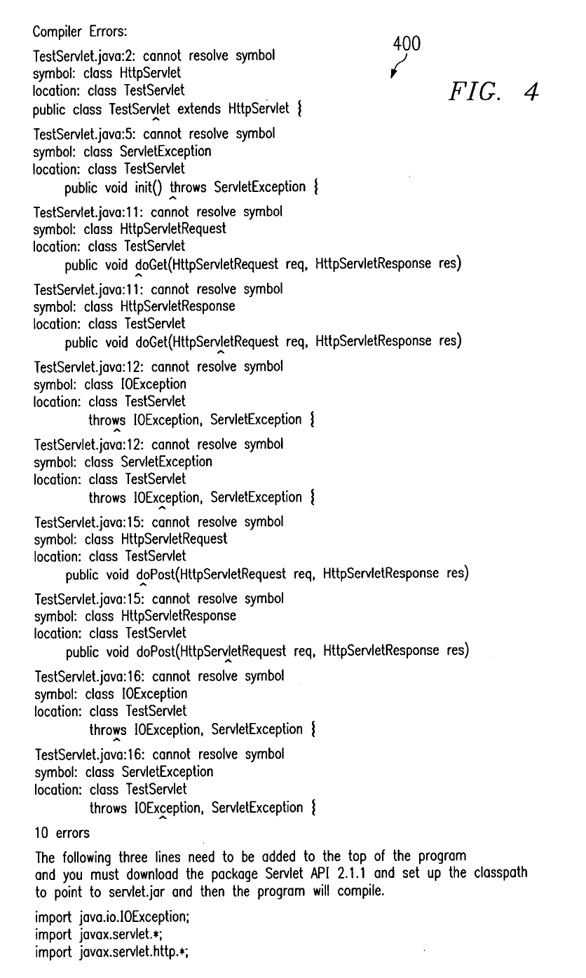

Turning now to FIG. 5, a diagram illustrating an entry in a database used in identifying source files is depicted in accordance with a preferred embodiment of the present invention. Entry 500 is an example of an entry within a database, such as database 318 in FIG. 3. Compiler error 502 represents the key used in the query to the database. This key is associated with search engine keywords 504, which represents the value returned in response to a query containing compiler error 502. Further, URL 506 also is located within entry 500 and is used to identify the search engine that should be utilized. URL 506 may change depending on the rating of different search engines if a rating system is implemented within the database. Alternatively, URL 506 need not be identified until a query is received and processed with URL 506 being selected by identifying the search engine having the highest point rating at that time.

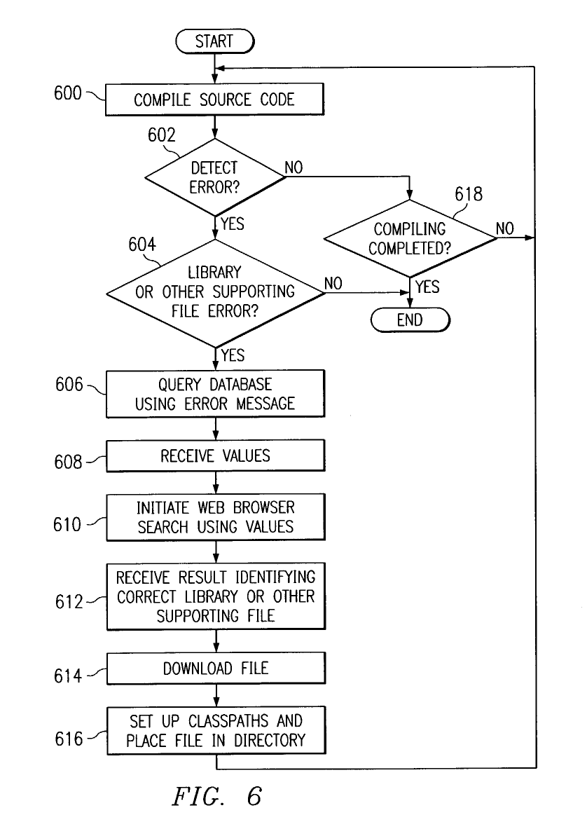

With reference now to FIG. 6, a flowchart of a process used for autonomically compiling a program is depicted in accordance with a preferred embodiment of the present invention. The process illustrated in FIG. 6 may be implemented in a resource tool, such as resource tool 314 in FIG. 3.

The process begins by compiling source code (step 600). A determination is made as to whether an error is detected (step 602). If an error is detected, a determination is made as to whether a library or other supporting file is identified as being missing or incorrect in the error message (step 604). If the error is for a missing or incorrect library or other supporting file, a database is queried using the error message (step 606). In step 606, the query may be generated by parsing the error message and identifying the name of the file that is identified as missing or incorrect. The error message also may be parsed to identify a method that is not supported by the particular library or other supporting file. Values are received from the database in response to the query (step 608) and a Web browser search using those values is initiated (step 610). A result identifying the correct library or other supporting file is received (step 612). The file is downloaded from the source (step 614). The classpaths are set up and the file is placed in the directory (step 616) with the process returning to step 600 to recompile the source code.

Returning again to step 604, if the error does not relate to a missing or incorrect library or other supporting file, the process terminates. With reference again to step 602, if an error is not detected, a determination is made as to whether the compiling is completed (step 618). If the compiling is completed, the process terminates. Otherwise, the process returns to step 600 as described above.

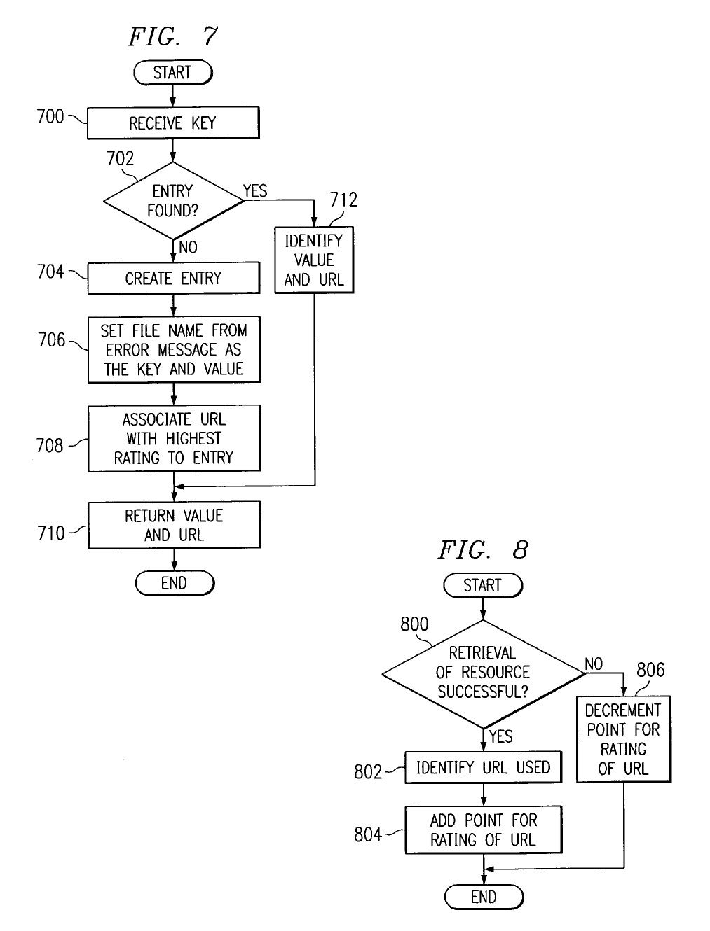

Turning now to FIG. 7, a flowchart of a process used for processing a query is depicted in accordance with a preferred embodiment of the present invention. The process illustrated in FIG. 7 may be implemented in a database, such as database 318 in FIG. 3.

The process begins by receiving a key (step 700). In these examples, the key contains text from a compiler error message, such as, for example, the name of the missing or incorrect file. A determination is made as to whether an entry is found (step 702). If no entry is found, an entry is created (step 704). The missing item is set from the error message as the key and value (step 706). The URL is associated with the highest rating to entry (step 708). The value and URL are returned (step 710) with the process terminating thereafter.

Returning again to step 702, if an entry is found, the value and URL are identified (step 712) and the process terminates. The URL identified in step 712 may be one associated with the value in the entry or may be dynamically identified through selecting a URL for a search engine having a highest rating at that time.

With reference now to FIG. 8, a flowchart of a process used for rating search engines in a database is depicted in accordance with a preferred embodiment of the present invention. The process illustrated in FIG. 8 may be implemented in a database, such as database 318 in FIG. 3.

The process begins by making a determination as to whether the retrieval of a resource was successful (step 800). If the retrieval of the resource was successful, the identified URL is used (step 802). A point is added for the rating of the URL (step 804) with the process terminating thereafter.

Turning again to step 800, if the retrieval of the resource was not successful, the rating of the URL is decremented by a point (step 806) and the process terminates thereafter.

Thus, the present invention provides an improved method, apparatus, and computer instructions for compiling programs from source code. The mechanism of the present invention provides an autonomic process for compiling programs for which user intervention is not required if an incorrect or missing source file is encountered during the compiling process. The mechanism of the present invention provides this advantage through identifying and locating the required file in response to detecting this type of error during the compilation process. The identified file is retrieved and placed in the appropriate directory. Thereafter, the compilation process is restarted or continued. In this manner, a programmer is not required to spend time searching for libraries and other supporting files for a successful compilation of a program.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for correcting compiler errors, the method comprising:
responsive to an error originating from a source file, searching a database to obtain keywords, wherein error messages are associated with keywords;
using the keywords to construct a search for a correct source file;
retrieving the correct source file from a source external to the data processing system; and
compiling the correct source file with other source files.

2. The method of claim 1, wherein the source file is a missing source file.

3. The method of claim 1, wherein the source file is an incorrect source file.

4. The method of claim 1, wherein the source file is a library file.

5. A method in a data processing system for compiling a program, the method comprising:
compiling a set of source files for the program;
responsive to an error message occurring in compiling a selected source file within the set of source files, querying a database using the error message to receive a response;
searching a distributed data processing system for a needed source file using the response;
responsive to locating the needed source file, downloading the needed source file to form a downloaded source file; and
compiling the set of source files using the downloaded source file.

6. The method of claim 5, wherein the response includes at least one keyword.

7. The method of claim 6, wherein the response further includes a location of a search engine in the distributed data processing system.

8. The method of claim 5, wherein the downloaded source file is a missing source file from the set of source files.

9. The method of claim 5, wherein the selected source file is an incorrect source file.

10. The method of claim 5, wherein the selected source file is a library file.

11. The method of claim 5, wherein the selected source file is an incorrect version and the downloaded source file is a correct version.

12. A data processing system for correcting compiler errors, the data processing system comprising:
a bus system;
a communications unit connected to the bus system;
a memory connected to the bus system, wherein the memory includes a set of instructions; and
a processing unit connected to the bus system, wherein the processing unit executes the set of instructions to search a database to obtain keywords in which error messages are associated with keywords in response to an error originating from a source file; use the keywords to construct a search for a correct source file; retrieve the correct source file from a source external to the data processing system; and compile the correct source file with other source files.

13. A data processing system for compiling a program, the data processing system comprising:
a bus system;
a communications unit connected to the bus system;
a memory connected to the bus system, wherein the memory includes a set of instructions; and
a processing unit connected to the bus system, wherein the processing unit executes the set of instructions to compile a set of source files for the program; query a database using the error message to receive a response in response to an error message occurring in compiling a selected source file within the set of source files; search a distributed data processing system for a needed source file using the response; download the needed source file to form a downloaded source file in response to locating the needed source file; and compile the set of source files using the downloaded source file.

14. A data processing system for correcting compiler errors, the data processing system comprising:
searching means, responsive to an error originating from a source file, for searching a database to obtain keywords, wherein error messages are associated with keywords;
using means for using the keywords to construct a search for a correct source file;
retrieving means for retrieving the correct source file from a source external to the data processing system; and
compiling means for compiling the correct source file with other source files.

15. The data processing system of claim 14, wherein the source file is a missing source file.

16. The data processing system of claim 14, wherein the source file is an incorrect source file.

17. The data processing system of claim 14, wherein the source file is a library file.

18. A data processing system for compiling a program, the data processing system comprising:
first compiling means for compiling a set of source files for the program;
querying means, responsive to an error message occurring in compiling a selected source file within the set of source files, for querying a database using the error message to receive a response;
searching means for searching a distributed data processing system for a needed source file using the response;
downloading means, responsive to locating the needed source file, for downloading the needed source file to form a downloaded source file; and
second compiling means for compiling the set of source files using the downloaded source file.

19. The data processing system of claim 18, wherein the response includes at least one keyword.

20. The data processing system of claim 19, wherein the response further includes a location of a search engine in the distributed data processing system.

21. The data processing system of claim 18, wherein the downloaded source file is a missing source file from the set of source files.

22. The data processing system of claim 18, wherein the selected source file is an incorrect source file.

23. The data processing system of claim 18, wherein the selected source file is a library file.

24. The data processing system of claim 18, wherein the selected source file is an incorrect version and the downloaded source file is a correct version.

25. A computer program product in a computer readable medium for correcting compiler errors, the computer program product comprising:
first instructions, responsive to an error originating from a source file, for searching a database to obtain keywords, wherein error messages are associated with keywords;
second instructions for using the keywords to construct a search for a correct source file;
third instructions for retrieving the correct source file from a source external to the data processing system; and
fourth instructions for compiling the correct source file with other source files.

26. A computer program product in a computer readable medium for compiling a program, the computer program product comprising:
first instructions for compiling a set of source files for the program;
second instructions, responsive to an error message occurring in compiling a selected source file within the set of source files, for querying a database using the error message to receive a response;
third instructions for searching a distributed data processing system for a needed source file using the response;
fourth instructions, responsive to locating the needed source file, for downloading the needed source file to form a downloaded source file; and
fifth instructions for compiling the set of source files using the downloaded source file.
